(19) United States
(12) Patent Application Publication
(10) Pub. No.: US 2009/0152250 A1
(43) Pub. Date: Jun. 18, 2009

(54) BEAM MODULATING APPARATUS FOR MOLD FABRICATION BY ULTRA-FAST LASER TECHNIQUE

(75) Inventors: TIEN-LI CHANG, Kaohsiung City (TW); HUNG-YI LIN, Hsinchu City (TW); MIN-CHIEH CHOU, Taipei City (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 12/120,587

(22) Filed: May 14, 2008

(30) Foreign Application Priority Data
Dec. 17, 2007 (TW) 096148166

(51) Int. Cl. B23K 26/073; B23K 26/06

(52) U.S. Cl. 219/121.73

(57) ABSTRACT

The present invention relates to a beam modulating apparatus for mold fabrication by ultra-fast laser technique. More particularly, the present invention discloses a beam modulating apparatus for fabricating micro-/nano-scaled structures, which adopts an energy shaping scheme for beam shape modulation while using the modulated beam for mold fabrication. Following the development of flexible electronic devices, such as flexible displays, all kinds of roller molds formed with micro-/nano-scaled structures are becoming the key issue for commercialization and mass production which require a breakthrough in ultra-precision machining and photo-lithography that overcomes the bottlenecks related to shape, size, thermal effect and precision for fabricating sub-micron sized structures and thus greatly enhancing product design capability and functionality. The present invention is capable of modulating pulse shape of an ultra-fast laser beam for making the energy distribution uniform on a mold, that it can be used directly on a curved surface of a metal cylinder since as a cold machining process which utilizes ultra-fast pulsed laser. Moreover, it can be used for forming micro-/nano-scaled structures of any complicated three-dimensional shapes on a mold with line width that is smaller than 10 μm while enabling the mold to be suitable for a roll-to-roll process so as to meet the requirement of cost reduction and value addition.

### BACKGROUND OF THE INVENTION

1. Field of the Invention

The present invention generally relates to a beam modulating apparatus for mold fabrication by ultra-fast laser technique and, more particularly, to a beam modulating apparatus for optical display mold fabrication integrated with micro-/nano-scaled roll-to-roll process to overcome the bottleneck in machining various materials and curved surfaces to achieve large-area mold fabrication and efficient machining. The present invention can be used in machining a curved surface of a metal cylinder to make the optical display industry more technology-intensive, high-profit and value-added.

2. Description of the Prior Art

In ultra-precision manufacturing, ultra-fast laser with ultra-short pulses has attracted tremendous attention because it exhibits high precision and high-efficiency characteristics. The femtosecond laser, among these ultra-fast laser candidates, has been widely used in machining process for mold fabrication. Moreover, the femtosecond laser with a pulse cycle about 5×10⁻¹⁵ sec is mostly used in biomedical, engineering, and micro-machining.

Please refer to FIG. 1, which is a schematic diagram of a conventional apparatus for mold machining according to U.S. Pat. No. 5,837,329. The apparatus comprises: a laser light source 11, a filter 12, a shutter 13, a shutter driver 14, a microscope objective 15, a motorized stage controller 16, a 3-D stage 17, a computer 18, a sample 19, and a nitrogen (N₂) nozzle 20. The high-energy and short-pulse laser used as a light source for machining has a wavelength of 900˜1100 nm. U.S. Pat. No. 5,837,329 is characterized in that a laser light beam generated by a laser light source 21 passes through a laser light irradiation device 22 to perform patterning machining on a roller 2. Meanwhile, a plurality of micro-scaled structures are formed on a curved surface of a cylinder. However, this method is problematic because only simplified patterns can be formed on a curved surface of a cylinder coated with an organic material thereon, instead of performing machining directly on a metal mold. Moreover, it is not feasible to form complicated patterns on the mold because verticality and planarity are not easily achieved.

Moreover, in U.S. Pat. No. 6,285,002, the femtosecond laser is used in a machining process. However, in this patent, only a filter is used to improve the laser beam quality, which is not sufficient to meet the requirement for mass production.

In these aforesaid patents, conventional continuous-wave laser and long wavelength laser are used, which cause thermal effects because a great amount of heat cannot be exhausted immediately. On the contrary, in the present invention, the femtosecond laser is advantageous in narrow pulse-width and heat-up time, in which the thermal effects are prevented because the heat can be exhausted immediately. As a result, the heating zone is smaller and thus the machining precision is significantly enhanced.

### SUMMARY OF THE INVENTION

It is an object of the present invention to provide to a beam modulating apparatus for mold fabrication by ultra-fast laser technique, using a beam shaper to integrate the optical machining system using the femtosecond laser. Therefore, the energy of the laser light beam is re-distributed to be uniform for a defined beam shape, unlike normal distribution for a conventional Gaussian pulse. As a result, the femtosecond laser beam is planarized and re-shaped to form a variety of micro-/nano-scaled structures. Moreover, the present invention can be used in directly machining a curved surface of a metal cylinder and roll-to-roll printing by micro-/nano-scaled roller molds to overcome problems in large-area materials such as machining time, residue and cost.

In order to achieve the foregoing object, the present invention provides beam modulating apparatus for mold fabrication, comprising a laser light generating device, a filter, a lens, a shutter and an objective to perform machining on a mold, wherein the laser light generating device comprises:

an oscillator capable of generating a laser light beam;

a beam shaper capable of modulating the laser light beam generated by the oscillator to achieve a pre-determined energy distribution;

a stretcher capable of stretching a waveform generated by the beam shaper to a pre-determined size;

an amplifier capable of amplifying the energy of the laser light beam output from the stretcher; and

a compressor capable of compressing the laser light beam output by the amplifier to a suitable size.

### BRIEF DESCRIPTION OF THE DRAWINGS

The objects, spirits and advantages of the preferred embodiment of the present invention will be readily understood by the accompanying drawings and detailed descriptions, wherein:

FIG. 1 is a schematic diagram of a conventional apparatus for mold machining according to U.S. Pat. No. 5,837,329;

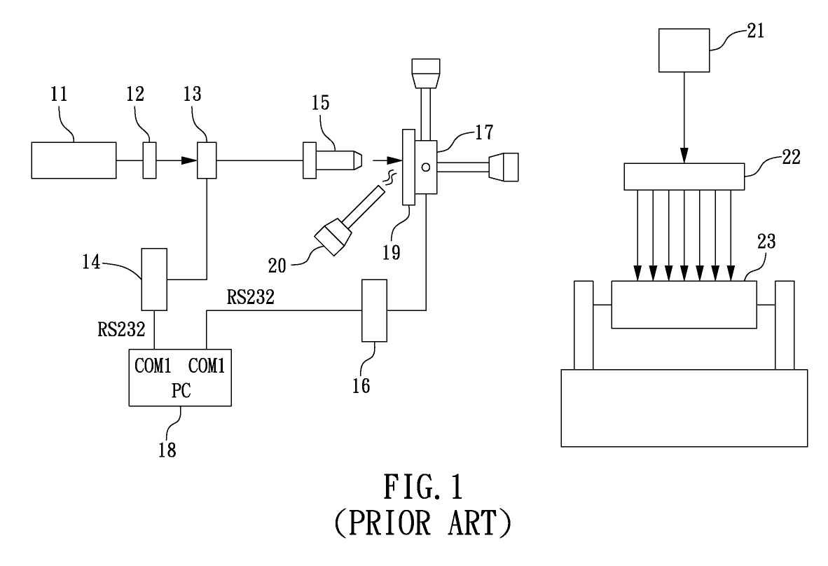

FIG. 2 is a schematic diagram of an apparatus for mold machining using ultra-fast laser according to the present invention;

FIG. 3 shows a pre-determined energy distribution of a laser light beam achieved by a beam shaper according to the present invention.

### DETAILED DESCRIPTION OF THE PREFERRED EMBODIMENT

The present invention can be exemplified but not limited by the preferred embodiment as described hereinafter.

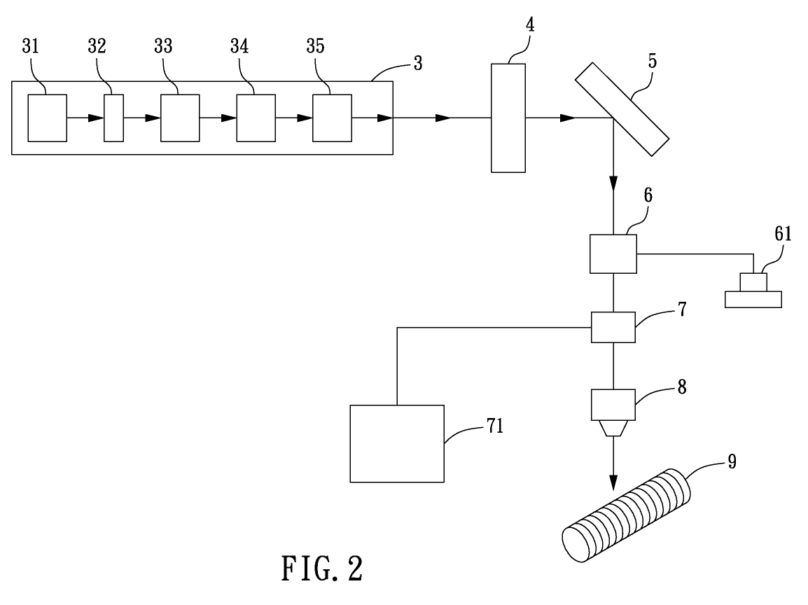

Please refer to FIG. 2, which is a schematic diagram of an apparatus for mold machining using ultra-fast laser according to the present invention. The apparatus for mold machining comprises a laser light generating device 3, a filter 4, a lens 5, a shutter 6, an objective 8 and a mold 9 to perform machining on a mold. The filter 4 is capable of filtering out the non-laser light beam. The lens 5 is capable of reflecting the laser light beam so that the size of the apparatus can be minimized. The shutter 6 is capable of controlling the on/off of the slits. The objective 8 is capable of re-focusing the laser light beam on the mold 9 so as to form a pre-determined machining pattern thereon. In the present embodiment, the mold 9 is a roller. However, the present invention is not restricted to the shape and material of the mold. Alternatively, the mold can comprises metal, quartz, glass, ceramic, silicon, acrylic or photo-resist. More particularly, the metal used in the mold can be copper, nickel or stainless steel. Moreover, the mold can be rectangular, polygonal, V-shaped, circular, cylindrical, spherical and non-spherical.

The on/off time of the shutter 6 can be controlled by an optics-based program (for example, Visual Basic).

Moreover, the apparatus for mold machining of the present invention further comprises a joulemeter 7 disposed between the shutter 6 and the objective 8 to transmit the power intensity of the laser light beam to an oscilloscope 71 to display thereon.

The laser light generating device 3 comprises: an oscillator 31, a beam shaper 32, a stretcher 33, an amplifier 34 and a compressor 35. The oscillator 31 is capable of generating a laser light beam. The laser light beam is ultra-fast laser. In the present embodiment, the ultra-fast laser is the femtosecond laser with a pulse cycle of 10⁻¹² to 10⁻¹⁵ sec. The beam shaper 32 is capable of modulating the laser light beam generated by the oscillator 31 to achieve a pre-determined energy distribution. The stretcher 33 is capable of stretching a waveform generated by the beam shaper 32 to a pre-determined size. The amplifier 34 is capable of amplifying the energy of the laser light beam output from the stretcher 33. The compressor 35 is capable of compressing the laser light beam output by the amplifier 34 to a suitable size.

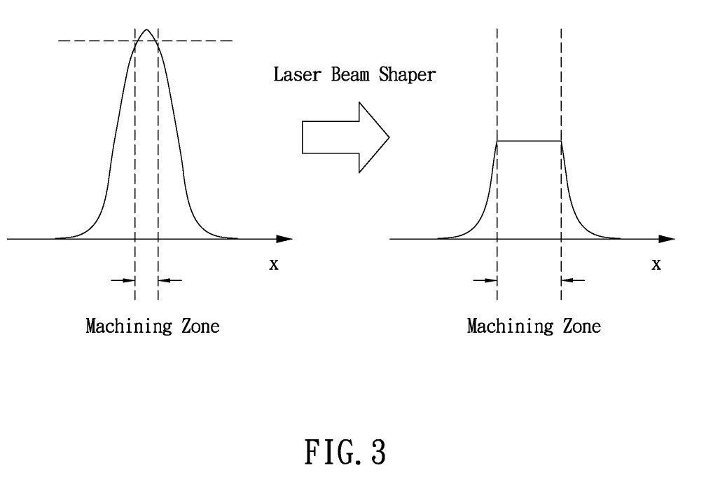

Please refer to FIG. 3, which shows a pre-determined energy distribution of a laser light beam achieved by a beam shaper according to the present invention. The present invention is used in the manufacturing of micro-/nano-scaled structures on a curved surface of a metal cylinder mold, which is characterized in that a beam shaper is used for beam modulation machining to modulate the beam shape of a laser light beam. For example, in the left figure of FIG. 3, the energy at the central portion of laser light beam is higher than that in the edge portion. Therefore, the machining zone is smaller when a pre-determined pattern is formed on the mold. In the left figure, since the laser light has been shaped by the beam shaper, the energy distribution is uniform, which results in a larger machining zone when a pre-determined pattern is formed on the mold. Therefore, the overall mold machining time is shortened.

Accordingly, as disclosed in FIG. 2 and FIG. 3, the present invention discloses a beam modulating apparatus for fabricating micro-/nano-scaled structures, which adopts an energy shaping scheme for beam shape modulation while using the modulated beam for mold fabrication. Following the development of flexible electronic devices, such as flexible displays, all kinds of roller molds formed with micro-/nano-scaled structures are becoming the key issue for commercialization and mass production which require a breakthrough in ultra-precision machining and photo-lithography that overcomes the bottlenecks related to shape, size, thermal effect and precision for fabricating sub-micron sized structures and thus greatly enhancing product design capability and functionality. The present invention is capable of modulating pulse shape of an ultra-fast laser beam for making the energy distribution uniform on a mold, that it can be used directly on a curved surface of a metal cylinder since as a cold machining process which utilizes ultra-fast pulsed laser. Moreover, it can be used for forming micro-/nano-scaled structures of any complicated three-dimensional shapes on a mold with line width that is smaller than 10 μm while enabling the mold to be suitable for a roll-to-roll process so as to meet the requirement of cost reduction and value addition.

Accordingly, the present invention discloses a beam modulating apparatus for optical display mold fabrication integrated with micro-/nano-scaled roll-to-roll process to overcome the bottleneck in machining various materials and curved surfaces to achieve large-area mold fabrication and efficient machining. Therefore, the present invention is useful, novel and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A beam modulating apparatus for mold fabrication, comprising a laser light generating device, a filter, a lens, a shutter and an objective to perform machining on a mold, wherein the laser light generating device comprises:
an oscillator capable of generating a laser light beam;
a beam shaper capable of modulating the laser light beam generated by the oscillator to achieve a pre-determined energy distribution;
a stretcher capable of stretching a waveform generated by the beam shaper to a pre-determined size;
an amplifier capable of amplifying the energy of the laser light beam output from the stretcher; and
a compressor capable of compressing the laser light beam output by the amplifier to a suitable size.

2. The beam modulating apparatus for mold fabrication as recited in claim 1, wherein the laser light beam is an ultra-fast laser light beam.

3. The beam modulating apparatus for mold fabrication as recited in claim 2, wherein the ultra-fast laser light beam is a femtosecond laser light beam with a pulse cycle within the range from 10⁻¹² to 10⁻¹⁵ sec.

4. The beam modulating apparatus for mold fabrication as recited in claim 1, wherein the mold comprises metal, quartz, glass, ceramic, silicon, acrylic, photo-resist.

5. The beam modulating apparatus for mold fabrication as recited in claim 4, wherein the metal comprises copper, nickel or stainless steel.

6. The beam modulating apparatus for mold fabrication as recited in claim 4, wherein the mold is rectangular, polygonal, V-shaped, circular, cylindrical, spherical or non-spherical.

7. The beam modulating apparatus for mold fabrication as recited in claim 1, wherein the shutter is controlled by an optics-based program to control the on/off time.

8. The beam modulating apparatus for mold fabrication as recited in claim 1, further comprising a joulemeter disposed between the shutter and the objective to transmit the power intensity of the laser light beam to an oscilloscope to display thereon.
